(19) United States
(12) Patent Application Publication
(10) Pub. No.: US 2016/0216669 A1
(43) Pub. Date: Jul. 28, 2016

(54) FIXING DEVICE THAT REDUCES GENERATION OF ULTRA FINE PARTICLES AND IMAGE FORMING APPARATUS INCLUDING THE SAME

(71) Applicant: KYOCERA Document Solutions Inc., Osaka (JP)

(72) Inventor: Sadanori NAKAE, Osaka (JP)

(73) Assignee: KYOCERA Document Solutions Inc., Osaka (JP)

(21) Appl. No.: 14/962,595

(22) Filed: Dec. 8, 2015

(30) Foreign Application Priority Data
Jan. 22, 2015 (JP) 2015-010073

(51) Int. Cl. G03G 15/20

(52) U.S. Cl. CPC G03G 15/2064; G03G 15/2007

(57) ABSTRACT

A fixing device according to one aspect of the disclosure includes a heat source, a fixing member, and a pressure member. The heat source generates infrared. The fixing member is heated from an inner circumferential surface side by the heat source. The pressure member forms a nip area in pressure contact with the fixing member. The nip area sandwiches a recording medium carrying an unfixed toner image between the fixing member and the pressure member. The nip area fuses the unfixed toner image to the recording medium. The fixing member has an inner circumferential surface, and the inner circumferential surface forms a heat absorbing portion that absorbs the infrared generated from the heat source. The heat absorbing portion is a polycondensate whose starting materials are silica and monosilane compounds. The heat absorbing portion has a fired film made of an organic-inorganic hybrid coating using an alcohol solution as a solvent.

### INCORPORATION BY REFERENCE

This application is based upon, and claims the benefit of priority from, corresponding Japanese Patent Application No. 2015-010073 filed in the Japan Patent Office on Jan. 22, 2015, the entire contents of which are incorporated herein by reference.

### BACKGROUND

Unless otherwise indicated herein, the description in this section is not prior art to the claims in this application and is not admitted to be prior art by inclusion in this section.

This applicant forms a heat absorbing portion onto an inner circumferential surface of a fixing roller in order to absorb infrared generated from a heat source. However, Ultra Fine Particles (UFP) is generated from the heat absorbing portion. To prevent the generated ultra fine particles (UFP) from diffusing outside a device, this applicant develops and applies a fixing device that causes infrared to transmit, and forms a coat layer that has a heat resistance at 300° C. or more on the heat absorbing portion by firing a ceramics-based coating.

The ultra fine particle (UFP) is a particle whose diameter is 100 nm or less among Suspended Particulate Matters (SPM).

A mechanism that the ultra fine particles (UFP) are generated from the heat absorbing portion is as follows. That is, the heat absorbing portion is formed by firing a black coating (such as Okitsumo coating (ceramics-based coating) No. 8264: a trade name) onto the inner circumferential surface of the fixing roller to absorb heat of the heat source efficiently so as to transmit the heat to the fixing roller. These black coatings are generated by adding a modified silicone to a metal oxide. Raising the temperature of the heat absorbing portion by the heat source generates a low molecular siloxane from the modified silicone of the heat absorbing portion. This low molecular siloxane diffuses as the ultra fine particles (UFP). A diffusion of these ultra fine particles (UFP) has been regarded as a problem environmentally.

### SUMMARY

A fixing device according to one aspect of the disclosure includes a heat source, a fixing member, and a pressure member. The heat source generates infrared. The fixing member is heated from an inner circumferential surface side by the heat source. The pressure member forms a nip area in pressure contact with the fixing member. The nip area sandwiches a recording medium carrying an unfixed toner image between the fixing member and the pressure member. The nip area fuses the unfixed toner image to the recording medium. The fixing member has an inner circumferential surface, and the inner circumferential surface forms a heat absorbing portion that absorbs the infrared generated from the heat source. The heat absorbing portion is a polycondensate whose starting materials are silica and monosilane compounds. The heat absorbing portion has a fired film made of an organic-inorganic hybrid coating using an alcohol solution as a solvent.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 schematically illustrates an internal structure of an image forming apparatus according to one embodiment of the disclosure;

FIG. 2 illustrates a configuration of a fixing roller according to the one embodiment;

FIG. 3 illustrates emissions of the ultra fine particles relative to the temperature change in respective test pipes of a working example and comparative examples;

FIG. 4 illustrates emissions of the ultra fine particles relative to a film thickness change of the heat absorbing portion made of a fired film of an organic-inorganic hybrid coating of the working example; and

FIG. 5 illustrates respective emissions of the ultra fine particles at firing temperatures of 150° C. and 300° C. in the heat absorbing portion made of a fired film of an organic-inorganic hybrid coating of the working example.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes an embodiment of the disclosure in detail based on the accompanying drawings. The disclosure should not be limited to the following embodiment.

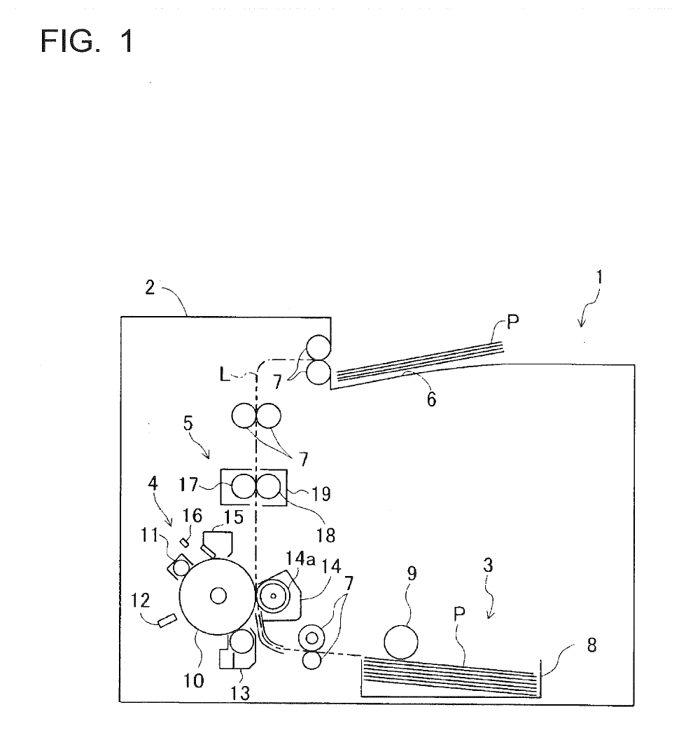

FIG. 1 illustrates an image forming apparatus 1 constituted of a laser printer according to one embodiment of the disclosure. The image forming apparatus 1 includes a housing 2 in which a paper sheet feeder 3, an image forming unit 4, and a fixing device 5 are housed along a sheet conveying path L in the order from the upstream side to the downstream side within. The sheet conveying path L has a downstream end that reaches a paper sheet discharge unit 6 located at the top surface portion of the housing 2. In the sheet conveying path L, a plurality of conveyance rollers 7, which sandwich a paper sheet (recording medium) P to convey, are arranged.

The paper sheet feeder 3 includes a sheet feed cassette 8, which houses the paper sheet P, and a pickup roller 9, which extracts the paper sheet P inside the sheet feed cassette 8 so as to send out it to the sheet conveying path L. The paper sheet P sent out from the sheet feed cassette 8 is supplied to the image forming unit 4 by the conveyance roller 7.

The image forming unit 4 transfers an unfixed toner image based on predetermined image data (such as image data of a document image received from an external terminal) to the paper sheet P supplied from the paper sheet feeder 3 and supplies the transferred paper sheet P to the fixing device 5.

In FIG. 1, the image forming unit 4 includes a photoreceptor drum 10, a charger 11, an exposure apparatus 12, a developing unit 13, a transfer unit 14, a cleaning apparatus 15, and a static eliminator 16. The charger 11 charges the circumference surface of the photoreceptor drum 10 uniformly. The exposure apparatus 12 irradiates the circumference surface of the photoreceptor drum 10 with a laser beam so as to form an electrostatic latent image in response to the predetermined image data. The developing unit 13 supplies a toner to the electrostatic latent image of the circumference surface of the photoreceptor drum 10 so as to visualize the electrostatic latent image as the unfixed toner image. The transfer unit 14 applies a transfer bias to a transfer roller 14a so as to transfer the unfixed toner image formed on the circumference surface of the photoreceptor drum 10 to the paper sheet P. The cleaning apparatus 15 cleans the attached and remained toner on the circumference surface of the photoreceptor drum 10 after the transferring. The static eliminator 16 removes a residual charge of the circumference surface of the photoreceptor drum 10.

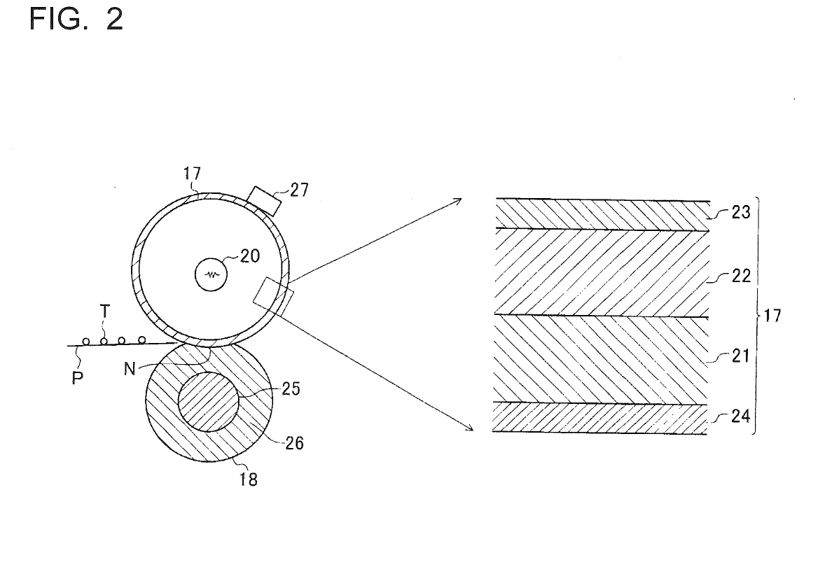

The fixing device 5 employs a roller fixing method where a fixing member of the fixing device 5 is a fixing roller 17. The fixing device 5 includes the fixing roller 17 and a pressure roller (pressure member) 18 within a housing 19. The fixing device 5, as illustrated in FIG. 2, forms a nip area N where the pressure roller 18 in pressure contact with the fixing roller 17 and sandwiches the paper sheet P carrying an unfixed toner image T with the fixing roller 17 so as to fuse the unfixed toner image T on the paper sheet P.

The paper sheet P on which the toner image is fused in the fixing device 5 is sent out to the downstream side of the sheet conveying path L by the fixing roller 17 and the pressure roller 18, and then is discharged to the paper sheet discharge unit 6 by the conveyance roller 7.

Inside the fixing roller 17, as illustrated in FIG. 2, for example, a halogen lamp 20 as a heat source, which generates infrared, is arranged, while the fixing roller 17 is heated from the inner circumferential surface side by the halogen lamp 20.

The fixing roller 17 includes a cylindrical shaped cored bar 21 made of metal such as aluminum or iron, which is excellent in heat conductivity. Onto the outer peripheral surface of the cored bar 21, an elastic layer 22 made of silicone rubber is formed. The elastic layer 22 is covered by a release layer 23 made of a fluororesin coating or a fluororesin tube in order to improve a release property when fusing the unfixed toner image T by the nip area N. Onto the inner circumferential surface of the fixing roller 17, a heat absorbing portion 24 that absorbs infrared generated from the halogen lamp 20 is formed by firing. One example of these thicknesses is a thickness from the inside of the fixing roller 17 to the heat absorbing portion 24 is 30 μm, a thickness of the cored bar (the diameter is 25.4 mm) 21 is 1 mm, a thickness of the elastic layer 22 is 270 μm, and a thickness of the release layer 23 is 30 μm. However, it is needless to say that this should not be construed in a limiting sense.

On the other hand, the pressure roller 18 includes a circular bar shaped cored bar 25 made of, for example, a synthetic resin, a metal, and other materials. Onto the outer peripheral surface of the cored bar 25, an elastic layer 26 made of silicone rubber is formed. The elastic layer 26 is covered with a release layer made of a fluororesin coating or a fluororesin tube (not illustrated). One example of these thicknesses is, with respect to the cored bar 25 whose diameter is 25 mm, a thickness of the elastic layer 26 is 5.5 mm, while a thickness of the release layer is 50 μm. However, it is needless to say that this should not be construed in a limiting sense.

In FIG. 2, the fixing roller 17 includes a thermistor 27 that detects a surface temperature of the fixing roller 17.

The heat absorbing portion 24 of the fixing roller 17, which employs an alcohol solution as a solvent, is a fired film of a polymer coating formed of mainly a polycondensate whose starting materials are silica and monosilane compounds. The firing is performed after forming an organic-inorganic hybrid coating film (heat absorbing portion 24) by combining strongly a hydroxyl group of silica particles containing colloidally dispersed inorganic materials, and a methoxy radical inside the monosilane compounds by a polycondensation reaction. This causes the heat absorbing portion 24 to have both properties of an organic material excellent in formability and an inorganic material excellent in a heat resistance and a weather resistance, and to be formed to a strong mesh-patterned coating film by a siloxane bond, such that pores are oriented in a vertical direction to the coating film.

Accordingly, the heat absorbing portion 24 enhances an absorbance of infrared generated from the halogen lamp 20. As a result, this ensures the enhanced absorbance of radiant heat of the halogen lamp 20 to transmit the heat to the fixing roller 17. This ensures the increased temperature of the fixing roller 17. When the fixing roller 17 reaches a predetermined temperature, the unfixed toner image T of the paper sheet P is fused on the paper sheet P at the nip area N.

Since an organic-inorganic hybrid coating, whose starting material is monosilane compounds, is a fired film of a polymer coating formed of mainly a siloxane bond obtained by a polycondensation, the organic-inorganic hybrid coating can reduce a modified silicone portion in the coating film. Accordingly, even if a temperature of this heat absorbing portion 24 increases, the heat absorbing portion 24 can reduce a generation of ultra fine particles (UFP) caused by a low molecular siloxane generated from a modified silicone substantially, thus ensuring the high generated temperature and a single layer of the heat absorbing portion 24. This eliminates the need for a double coating, thus ensuring the reduced labor for coating and firing. Furthermore, since one type coating is enough, the heat absorbing portion 24 can be formed easily and at low-cost.

Furthermore, since an alcohol solution is used as a solvent for the organic-inorganic hybrid coating, thus ensuring the reduced influence to the human body. And use of an organic solvent such as toluene eliminates the need for an air exhausting device and a deodorization device required for work environment maintenance, thus ensuring the reduced equipment investment.

The elastic layer 22 uses silicone rubber. However, since the elastic layer 22 is covered with the cored bar 21 and the release layer 23, the ultra fine particles (UFP) caused by the modified silicone does not diffuse outside.

It is preferred that the heat absorbing portion 24 have a film thickness of 10 μm to 30 μm and a firing temperature of 200° C. to 450° C. Each of them is preferred from an aspect that reduces the ultra fine particles (UFP) generated from an organic matter.

Next, emissions of the ultra fine particles (UFP) are evaluated using test pipes including a heat absorbing portion in the following manner.

### Forming Method of Heat Absorbing Portion (Working Example)

An organic-inorganic hybrid coating is manufactured mixing the mixture (20% weight) of silica with grain diameters of 5 nm to 100 nm and a monosilane compounds, a color pigment (30% weight) made of a copper-iron-manganese oxide and a black pigment, an isopropyl alcohol (25% weight), and an extender pigment (20% weight: such as alumina, talc, mica, muscovite, or nepheline syenite).

This organic-inorganic hybrid coating is applied over the inner circumferential surface of an aluminum pipe A5052 with a diameter of 20 mm and a length of 260 mm, at a thickness of 30 μm, and then the aluminum pipe A5052 is fired at 400° C. in one hour so as to obtain a test pipe.

This prepares the heat absorbing portion of an organic-inorganic hybrid coating film by reacting and combining strongly a hydroxyl group of silica particles containing colloidally dispersed inorganic materials and a methoxy radical within the monosilane compounds.

### Comparative Example 1

A ceramics-based coating is manufactured mixing a silicone resin: 20% weight, a color pigment made of a copper-iron-manganese oxide and a black pigment: 25% weight, an organic solvent such as toluene: 40% weight, a mineral pigment made of such as magnesium silicate and aluminum borate: 10% weight, and another additive: 5% weight.

This ceramics-based coating is applied over the inner circumferential surface of an aluminum pipe A5052, whose diameter is 25 mm and whose length is 260 mm, at 30 μm thickness, and then the aluminum pipe A5052 is fired at 400° C. in one hour so as to obtain a test pipe.

### Comparative Example 2

A ceramics-based coating is manufactured mixing a silicone resin (15% weight), a color pigment (10% weight) made of a copper-iron-manganese-aluminum oxide and a black pigment, an organic solvent (50% weight) such as toluene, a mineral pigment (20% weight) made of such as a magnesium silicate and muscovite, and another additive (5% weight).

This ceramics-based coating is applied over the inner circumferential surface of an aluminum pipe A5052 with a diameter of 25 mm and a length of 260 mm, at a thickness of 30 μm, and then the aluminum pipe A5052 is fired at 400° C. in one hour so as to obtain a test pipe.

### Method of Measuring of Emission of Ultra Fine Particles (UFP) [number]

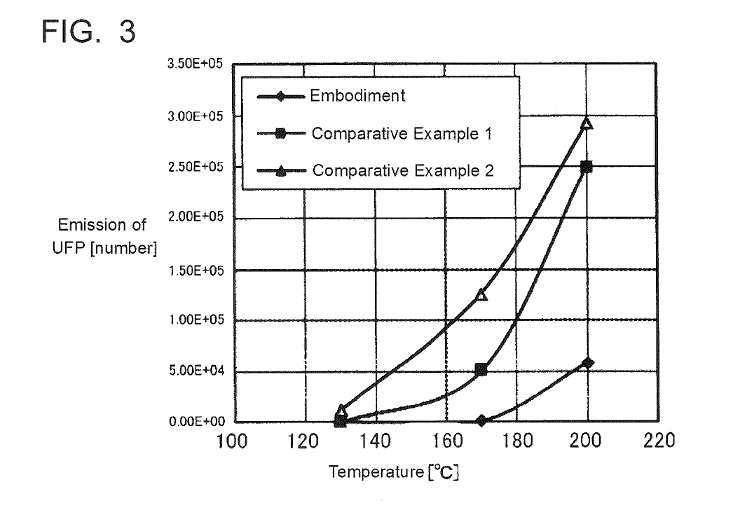

The test pipe is entered in a measurement chamber with a size of 1 m³, and a halogen lamp is inserted to the inside of the test pipe. While controlling the respective surface temperatures of the test pipes at 130° C., 170° C., and 200° C., measurements in 10 minutes are executed, and each maximum value of the ultra fine particles (UFP) generated per unit time is evaluated. At the measurement, a portable Condensation Particle Counter (CPC) mode13007 (manufactured by TSI Incorporated.: Saint Paul, Minn., the United States of America) is employed. In FIG. 3, the measurement result is illustrated.

FIG. 3 is a graph whose horizontal axis is a surface temperature of the test pipe [° C.] and whose vertical axis is emission of the ultra fine particles (UFP) [number]. In FIG. 3, symbols ♦(working example), ▪(comparative example 1), and ▴(comparative example 2) indicate respective measurement points.

As illustrated in FIG. 3, there are no significant differences for the emissions of the ultra fine particles (UFP) [number] of the test pipes of the working example, the comparative example 1, and the comparative example 2 at the surface temperature of 130° C. However, when the surface temperature is 170° C., whereas there is no change in the working example, the comparative example 1 and the comparative example 2 increase to 5.00E+04 and 1.25E+05, respectively. When the surface temperature is 200° C., whereas the working example only exceeds 5.00E+04 slightly, the comparative example 1 and the comparative example 2 increase sharply to nearly 2.50E+05 and 3.00E+05, respectively. Thus, the working example reduced the emission of the ultra fine particles (UFP) [number], thus ensuring the satisfactory result.

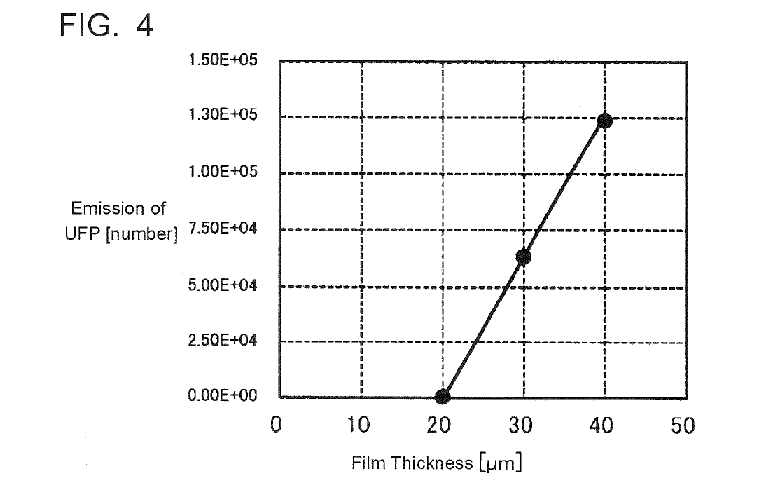

FIG. 4 is a graph that indicates emissions of the ultra fine particles (UFP) [number] relative to a film thickness change of the test pipe in the working example, which is the heat absorbing portion made of the fired film of the organic-inorganic hybrid coating. The emission increases to nearly the intermediate between 5.00E+04 and 7.50E+04 at a film thickness of 30 μm. This result supports that it is preferred that the film thickness of the heat absorbing portion be 10 μm to 30 μm.

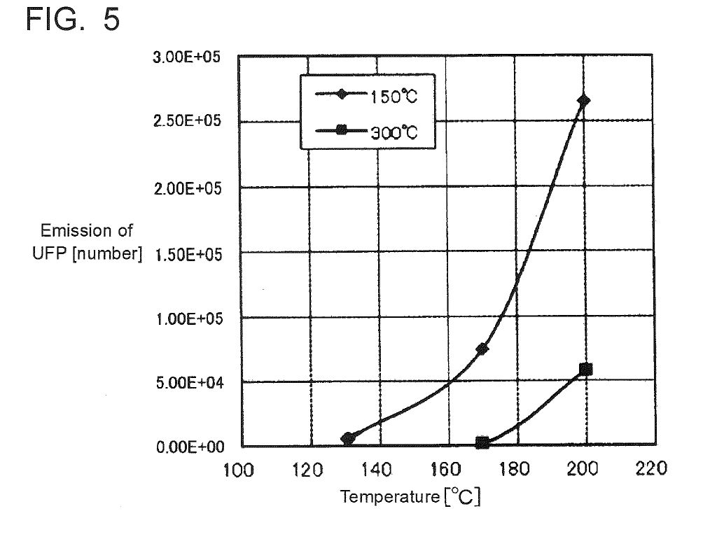

FIG. 5 is a graph that indicates emissions of the ultra fine particles (UFP) [number] of the test pipe in the working example, which the heat absorbing portion made of the fired film of the organic-inorganic hybrid coating at the firing temperatures of 150° C. and 300° C. When the firing temperature is 150° C., while the surface temperature of the test pipe becomes 200° C., the emission of the ultra fine particles (UFP) [number] exceeds 2.50E+05. This shows that since a sintering is insufficient and there remains room for hardening the coating film, an organic matter cannot be suppressed. On the other hand, when the firing temperature is 300° C., even if the surface temperature of the test pipe becomes 200° C., the emission of the ultra fine particles (UFP) [number] is low, 5.00E+04. This shows that since a sintering is sufficiently performed and the coating film is completely hardened, an organic matter can be suppressed. Incidentally, since a fixing temperature is about 200° C., it is preferred that the firing temperature of the heat absorbing portion be 200° C. to 450° C.

While in the embodiment the fixing device 5 as an example employs the roller fixing method where a fixing member of the fixing device 5 is the fixing roller 17, the fixing device 5 may employ a belt fixing method where the fixing member is a fixing belt.

In the embodiment an example that the image forming apparatus 1 is a printer is indicated. However, this should not be construed in a limiting sense. The image forming apparatus 1 may be, for example, a copier, a facsimile, a multi-functional peripheral or similar device.

As described above, the disclosure is effective for a fixing device that includes a heat absorbing portion onto the inner circumferential surface of a fixing member made of a fixing roller or a fixing belt, and an image forming apparatus including these.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A fixing device, comprising:
a heat source that generates infrared;
a fixing member heated from an inner circumferential surface side by the heat source; and
a pressure member that forms a nip area in pressure contact with the fixing member, the nip area sandwiching a recording medium carrying an unfixed toner image between the fixing member and the pressure member, the nip area fusing the unfixed toner image to the recording medium,
wherein the fixing member has an inner circumferential surface, and the inner circumferential surface forms a heat absorbing portion that absorbs the infrared generated from the heat source, the heat absorbing portion being a polycondensate whose starting materials are silica and monosilane compounds, the heat absorbing portion having a fired film made of an organic-inorganic hybrid coating using an alcohol solution as a solvent.

2. The fixing device according to claim 1,
wherein the heat absorbing portion has a film thickness of 10 μm to 30 μm.

3. The fixing device according to claim 1,
wherein the heat absorbing portion has a firing temperature of 200° C. to 450° C.

4. The fixing device according to claim 1,
wherein the fixing member includes a fixing roller.

5. The fixing device according to claim 1,
wherein the fixing member includes a fixing belt.

6. An image forming apparatus comprising
the fixing device according to claim 1.
